(19) United States
(12) Patent Application Publication
(10) Pub. No.: US 2019/0301727 A1
(43) Pub. Date: Oct. 3, 2019

(54) LOUDSPEAKER LUMINAIRE WITH LIGHT PIPE

(71) Applicant: ABL IP Holding LLC, Atlanta, GA (US)

(72) Inventor: Philip Sieczkowski, Lawrenceville, GA (US)

(21) Appl. No.: 16/364,754

(22) Filed: Mar. 26, 2019

Related U.S. Application Data
(60) Provisional application No. 62/649,062, filed on Mar. 28, 2018.

(51) Int. Cl. F21V 33/00; F21V 8/00; F21V 17/10; H04R 1/02

(52) U.S. Cl. CPC F21V 33/0056; G02B 6/0005; F21Y 2115/10; H04R 1/028; H04R 1/023; F21V 17/104

(57) ABSTRACT

A luminaire includes a loudspeaker coupled with a housing, one or more light sources coupled with the housing, and a light pipe, coupled with the housing, that forms a grille portion for the loudspeaker. The light pipe transfers light to one or more light-emitting surfaces that emit the light from the luminaire. A light pipe includes monolithically formed first and second portions of an optical material. The first portion is a perforated plate characterized by a perimeter and defining a first light-emitting surface. The second portion extends away from the perimeter, forms one or more light coupling surfaces that receive light from one or more light sources, and defines a second light-emitting surface. In operation, when the light is received into the light coupling surfaces from the light sources, at least a portion of the light emits from the first and second light-emitting surfaces.

### CROSS-REFERENCE TO RELATED APPLICATIONS

This application claims the benefit of priority to U.S. Provisional Patent Application No. 62/649,062, filed Mar. 28, 2018, which is incorporated herein in its entirety for all purposes.

### BACKGROUND

Luminaires, or light fixtures, for built-in installation may be designed to meet goals such as emitted light distribution, power consumption, cost, size, and visual aesthetics. Loudspeakers for built-in installation may be designed to meet multiple goals such as acoustic functionality, cost, size, and visual aesthetics. Certain luminaires exist that combine loudspeaker and light fixture functions.

### SUMMARY

In one or more embodiments, a luminaire includes a loudspeaker coupled with a housing, one or more light sources coupled with the housing, and a light pipe. The light pipe transfers light from the one or more light sources, to one or more light-emitting surfaces that emit the light from the luminaire.

In one or more embodiments, a light pipe includes monolithically formed first and second portions of an optical material. The first portion is a perforated plate characterized by a perimeter and defining a first light-emitting surface. The second portion extends away from the perimeter of the plate, forms one or more light coupling surfaces operable to receive light from one or more light sources, and defines a second light-emitting surface. In operation, when the light is received into the one or more light coupling surfaces from the one or more light sources, at least a portion of the light emits from the first and second light-emitting surfaces.

### BRIEF DESCRIPTION OF THE DRAWINGS

Embodiments are described in detail below with reference to the following figures.

FIG. 1 is a schematic cross-sectional view illustrating a loudspeaker luminaire that includes a light pipe, according to one or more embodiments.

FIG. 1A provides an enlarged view of the region noted as A in FIG. 1.

FIG. 2 is a partially exploded, schematic cross-sectional view illustrating part of the luminaire shown in FIG. 1, and viewed at a downward angle, according to one or more embodiments.

FIG. 3 is partially exploded, schematic cross-sectional view illustrating part of the luminaire illustrated in FIG. 1, but viewed at an upward angle, according to one or more embodiments.

FIG. 4 provides a cross-sectional cutaway view of the light pipe shown in FIG. 1, according to one or more embodiments.

FIG. 5 provides a bottom plan view of the light pipe shown in FIG. 1, according to one or more embodiments.

FIG. 6 provides a top plan view of the light pipe shown in FIG. 1, according to one or more embodiments.

FIG. 7 illustrates another luminaire that includes a light pipe, according to one or more embodiments.

FIG. 8 provides a cross-sectional cutaway view of the light pipe shown in FIG. 7, according to one or more embodiments.

### DETAILED DESCRIPTION

The subject matter of embodiments of the present invention is described here with specificity to meet statutory requirements, but this description is not intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Each example is provided by way of illustration and/or explanation, and not as a limitation. For instance, features illustrated or described as part of one embodiment may be used on another embodiment to yield a further embodiment. Upon reading and comprehending the present disclosure, one of ordinary skill in the art will readily conceive many equivalents, extensions, and alternatives to the specific, disclosed luminaire types, all of which are within the scope of embodiments herein.

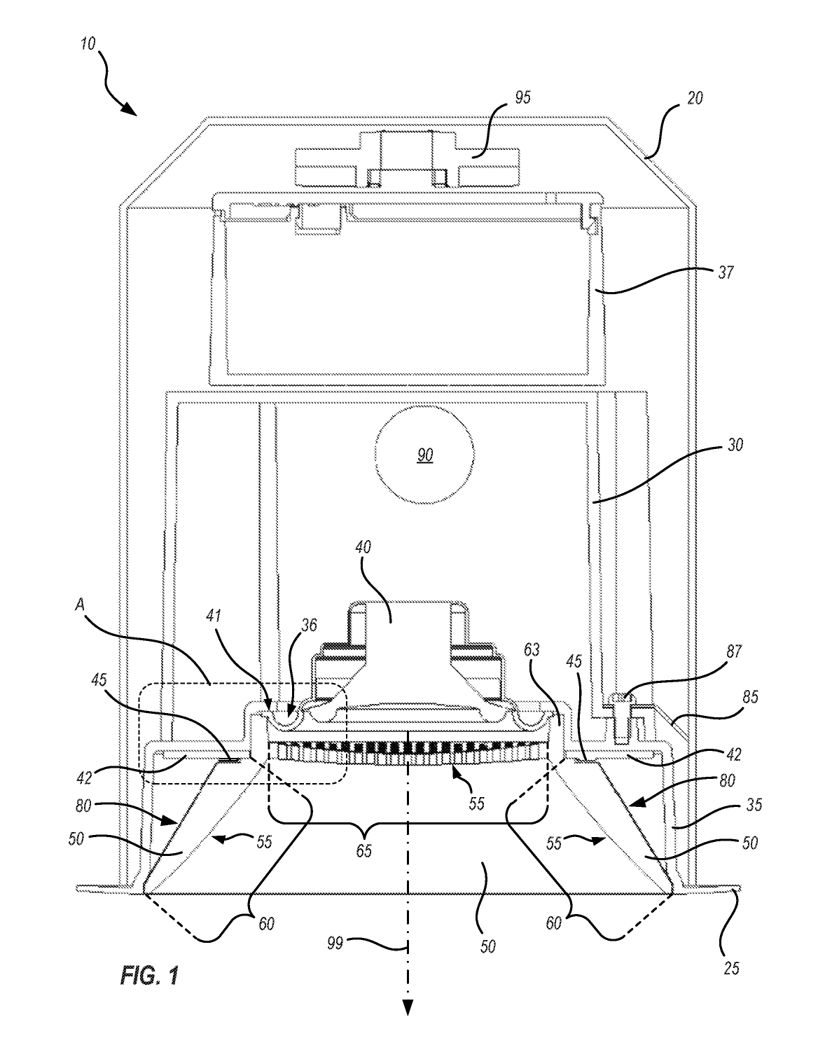

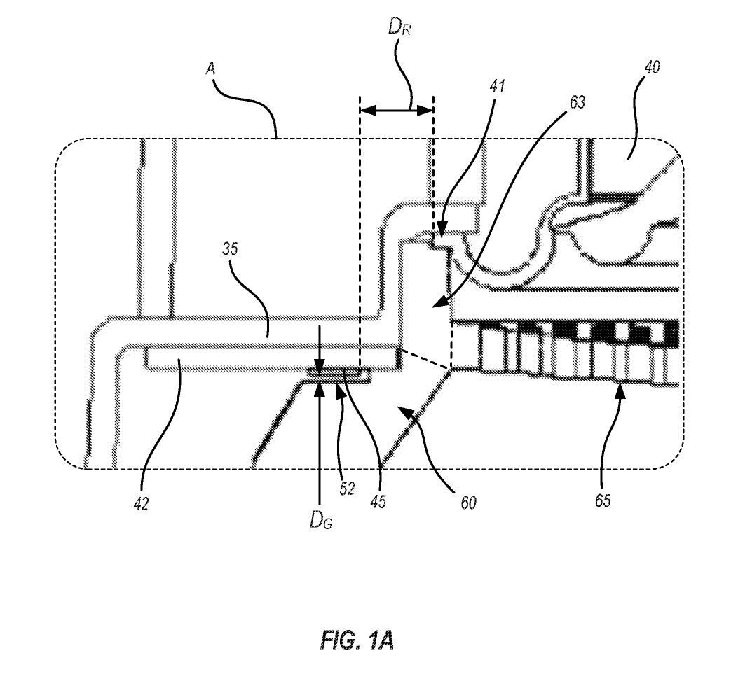

In the following description, positional terms like “above,” “below,” “vertical,” “horizontal” and the like are sometimes used to aid in understanding features illustrated in the drawings as presented, that is, in the orientation in which labels of the drawings read normally. These meanings are adhered to, notwithstanding that the luminaires herein may be mounted to surfaces that are not horizontal. Also, the relative terms “proximal” and “distal” are used relative to the uppermost features of the luminaire shown in FIG. 1; that is, locations nearer to the physical top of recessed can 20 are proximal and locations nearer to trim ring 25 are distal.

Certain embodiments herein provide luminaires that also include loudspeaker functionality. In these embodiments, a loudspeaker is mounted within a luminaire that may then be placed within a recessed “can” type fixture. One or more light sources are used to produce light, and one or more light pipes are used to transfer the light from the light sources to one or more light-emitting surfaces. Light pipe 50 confers several advantages, as described herein.

FIG. 1 is a schematic cross-sectional view illustrating a loudspeaker luminaire 10 that includes a light pipe 50. Luminaire 10 mounts within a recessed can 20. In the embodiment shown, luminaire 10 includes a proximal housing 30 and a distal housing 35, although proximal housing 30 and a distal housing 35 may be combined into a single housing in other embodiments. Distal housing 35 couples with a loudspeaker 40, and a circuit board (e.g., a printed circuit board or PCB) 42 that provides power to light sources 45. Light sources 45 may be light-emitting diodes (LEDs), which are advantageous due to their small size. In some embodiments, light sources 45 may be packaged, but in FIG. 1, light sources 45 are illustrated as unpackaged LEDs (e.g., LED chips mounted directly to circuit board 42).

Loudspeaker 40 and recessed can 20 are typically round in plan view, but other shapes may be used with appropriate modification of other shapes discussed herein. That is, although many of the discussions below include housings and other elements that are circularly symmetric about an optical axis 99, and incorporate a round loudspeaker 40, oval or other shapes of loudspeaker 40 may also be used with the housings and other elements modified accordingly. Similarly, loudspeakers 40 of any shape can be utilized with recessed cans or other housings that are not necessarily circular in plan view. Upon reading and comprehending the present disclosure, one of ordinary skill in the art will readily conceive of many equivalents, extensions, and alternatives.

In certain embodiments, distal housing 35 is annular shaped with one, two or more steps in height. Loudspeaker 40 is oriented such that its sound emitting surface faces downward, to emit sound out of a distal end of luminaire 10. In certain embodiments, a back side of loudspeaker 40 extends through a central aperture 36 of distal housing 35, such that an outer rim 41 of loudspeaker 40 abuts an underside of an uppermost step of distal housing 35, about a periphery of aperture 36, as illustrated. A region labeled A in FIG. 1 is illustrated in greater detail in FIG. 1A.

Circuit board 42 is typically affixed to an underside of distal housing 35 by one or more fasteners and/or adhesives, and the location at which circuit board 42 is affixed may be an underside of a second step of distal housing 35, as illustrated. When distal housing 35 is annular (e.g., to fit within a standard cylindrical recessed can 20) circuit board 42 may accordingly be annular shaped. Luminaire 10 also includes a light pipe 50 that transfers light from light sources 45 to light-emitting surfaces 55. Light pipe 50 includes a distal portion 60, a grille portion 65 and a proximal portion 63, as shown. Distal portion 60, grille portion 65 and proximal portion 63 are typically monolithically formed with one another (e.g., by molding).

Light-emitting surfaces 55 are surfaces of light pipe 50 that are located generally around and/or underneath loudspeaker 40. One such light-emitting surface 55 may be a surface of distal portion 60 that encircles loudspeaker 40, and is generally in the shape of a truncated cone (e.g., loudspeaker 40 is approximately where an apex of the cone would be, were it not truncated). Inner and outer surfaces of distal portion 60 may vary from an exact conical shape as needed; for example, distal portion 60 is shown in FIG. 1 as thickest nearer light sources 45 and thinner nearer a distal end of luminaire 10. Also, light-emitting surface 55 is downwardly convex in the embodiment shown, but may be straight or downwardly concave in other embodiments.

Grille portion 65 of light pipe 50 is a perforated plate that acts as a protective grille for loudspeaker 40, so that loudspeaker 40 can emit sound through grille portion 65, yet grille portion 65 can protect loudspeaker 40 from incidental contact with other objects. Distal portion 60 adjoins grille portion 65 about a perimeter of grille portion 65. When loudspeaker 40 is circular, grille portion 65 will be a disk, and the perimeter of grille portion 65 will be a circumference of the disk. A distal surface of grille portion 65 is another light-emitting surface 55. Because distal portion 60 adjoins grille portion 65, some of the light introduced into light pipe 50 will internally reflect and scatter into grille portion 65, and be emitted from light-emitting surface 55. Thus, in certain embodiments, light pipe 50 can provide protective, acoustic and optical functionality.

Luminaire 10 typically includes (but need not always include) a proximal housing 30 that encloses a back side of loudspeaker 40. Proximal housing 30 fastens to distal housing 35. In some embodiments, proximal housing 30 provides a relatively tight seal against an upper surface of distal housing 35 to create an enclosed air space around the back side of loudspeaker 40, to assist performance of certain loudspeakers 40. In some of these and other embodiments, one or more fasteners 87 can be used to fasten proximal housing 30 to distal housing 35, for example fasteners 87 may be screws, as shown in FIG. 1. However, other kinds of fasteners 87 can be used, or proximal and distal housings 30 and 35 may be joined in other ways such as through an interference fit, with an adhesive, by snapping together, or the like. Certain fasteners 87 used to join proximal and distal housings 30 and 35 may also advantageously connect one or more retainers 85 that hold luminaire 10 within recessed can 20, as discussed further below.

Luminaire 10 may also include an optional driver housing 37 located above proximal and distal housings 30 and 35. Driver housing 37 may include one or more drivers to drive light sources 45, and optional external power connections 95 may be provided as part of, or may be atop, driver housing 37. Driver housing 37 advantageously contains all high voltage circuitry for luminaire 10, as may be required by electrical codes. The circuitry within driver housing 37 provides lower voltage outputs to the luminaire, such as low voltage, direct current (DC) power driving light sources 45, and low voltage (e.g., 1.5V, 3V, 5V, 12V or 24V) power supplies for loudspeaker 40 and for other functions such as Bluetooth connectivity. Driver housing 37, when present, may be mechanically separate from proximal and/or distal housings 30 and 35, or may be fastened to, or integrated therewith (e.g., as a section of a single, cast or molded, housing). Power connections and the like (for example, wires connecting power connections 95, circuitry within driver housing 37, the circuit board, loudspeaker 40 and battery 90) are not shown, for clarity of illustration.

In embodiments, light pipe 50 typically engages with distal housing 35. In some of these embodiments, proximal portion 63 and distal housing 35 form threaded surfaces so that light pipe 50 can screw into distal housing 35, as discussed below, however other forms of engaging light pipe 50 with distal housing 35 are possible.

In use, luminaire 10 is installed within, and can optionally include, a recessed can 20, such as a 6 inch or 4 inch diameter recessed can, or other recessed can sizes, as discussed below. That is, luminaire 10 may be either provided with can 20, or luminaire 10 can be installed in an existing can 20. Distal housing 35 is positioned within recessed can 20 such that light is emitted downwardly from can 20, and may be held in place within can 20 using one or more retainers, such as retainer 85 shown in FIG. 1. Retainers 85 may advantageously be, for example, leaf springs that couple with distal and proximal housings 35 and 30 through the same fasteners 87 that connect the housings. Retainer 85 shown in FIG. 1 extends outward from fastener 87, then angles downwardly. During installation, luminaire 10 can be first connected to a power source using power connections 95, then pushed upwards into recessed can 20 until retainer 85 engages against sides of can 20, retaining luminaire 10 within can 20. Other types of retainers 85 can be used. One type of retainer 85 is formed of spring material that optionally bends first upwardly, then outwardly and downwardly, compressing against sides of can 20. Advantageously, three such retainers 85 can be used, spaced about equally within can 20 so that distal and proximal housings 35 and 30 are centered therein. Another type of retainer 85 includes torsion springs with upwardly extending hooks that can be compressed and inserted into a slot provided by the can 20. The springs expand the hooks outwardly above the slot after luminaire 10 is pushed into place within can 20, holding luminaire 10 in place. Another type of retainer 85 is a twist-lock or bayonet style connector in which a retaining feature slides upwardly into a groove or slot provided by recessed can 20. Upon reaching a certain height such that the retaining feature clears an end of the groove, luminaire 10 can be twisted, moving the retaining feature away from the groove so that luminaire 10 is retained within can 20. Upon reading and comprehending the present disclosure, one of ordinary skill in the art will readily conceive of many equivalents, extensions, and alternatives.

Distal housing 35 can include an optional trim flange 25. In embodiments, trim flange 25 extends outwardly from a bottommost step of distal housing 35, as shown in FIG. 1. When luminaire 10 is installed, trim flange 25 may cover a gap between a mounting hole in a ceiling and recessed can 20, to impart a polished appearance to the installation. Advantageously, trim flange 25 can be formed with distal housing 35, for simplicity of manufacturing. Alternatively, if desired, trim flange 25 can be formed separately to provide design flexibility (e.g., the ability to install a trim flange 25 having a certain finish or appearance, and/or swap out one trim flange 25 for another, before or after installation).

Recessed can 20 is typically cylindrical, but can be formed in other shapes. When can 20 is cylindrical, and when the sound emitting side of loudspeaker 40 is circular, distal housing 35 can be mounted such that loudspeaker 40 is concentric with can 20, and projects sound through a circular distal end of can 20.

Light pipe 50 generally encircles a distal end of loudspeaker 40 and extends toward a distal end of distal housing 35 and recessed can 20. Typically, no intervening structure is disposed between grille portion 65 of light pipe 50, and loudspeaker 40. FIG. 1 also indicates a position of an optional reflector 80 mounted behind light pipe 50, and an optional battery 90.

Further items may be added for enhanced functionality and/or aesthetic appeal. For example, infrared, optical, acoustic and/or radio frequency sensors may be added to provide functions such as motion sensing, imaging, microphone, and/or short or intermediate range wireless functions such as Bluetooth, Wi-Fi and the like. In particular, Bluetooth functionality can be used to stream audio input to loudspeaker 40, can be used to control the light sources, and can provide on/off, dimming, and/or other control functions for loudspeaker 40 and the light sources. Optional battery 90 may be used to support Bluetooth and/or other functions even when the fixture is “off”—i.e., not receiving AC power, and/or not emitting light. Circuitry for performing these functions can be located within proximal housing 30 and/or driver housing 37, but is not shown, for clarity of illustration.

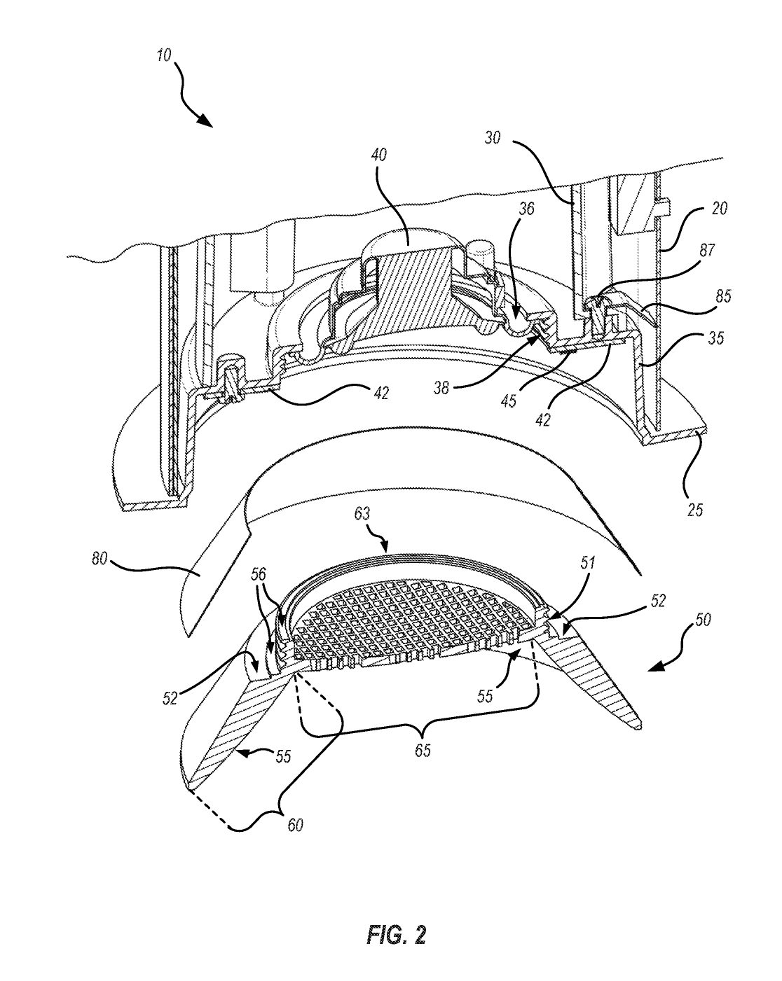

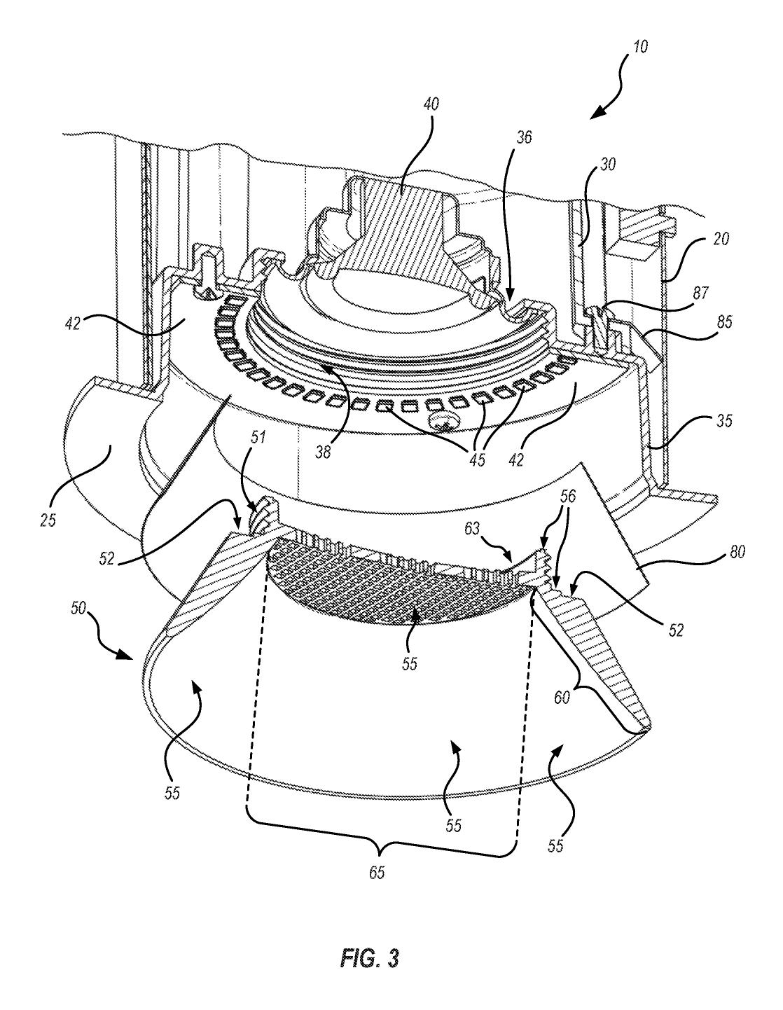

FIG. 1A provides an enlarged view of the region noted as A in FIG. 1. Distal portion 60, grille portion 65 and proximal portion 63 of light pipe 50 are shown demarcated by broken lines, but when light pipe 50 is formed monolithically, boundaries among distal portion 60, grille portion 65 and proximal portion 63 are arbitrary and all such sections may generally be described as adjoining one another. Proximal portion 63 extends upwardly from the perimeter of grille portion 65 and is typically in mechanical engagement with distal housing 35. PCB 42 and one light source 45 are shown; it is understood that distal housing 35, PCB 42 and distal portion 60 continue in and out of the plane of FIG. 1A (e.g., as shown in FIGS. 2 and 3) so that PCB 42 can support multiple light sources 45 in proximity with distal portion 60. Distal portion 60 forms a light coupling surface 52, and light sources 45 form light-emitting surfaces that are in parallel relation with coupling surface 52, as shown. Geometries of distal housing 42, light pipe 50, PCB 42 and light sources 45, and engagements thereof, are arranged to form a gap DG between light sources 45 and light coupling surface 52, and to provide a radial distance DR between an outer rim 41 of loudspeaker 40, and light sources 45. Advantageously, DG can be two millimeters or less, and DR can be less than about six millimeters.

As discussed further below, the configuration shown and described herein is advantageous in that light pipe 50 and its engagement with loudspeaker 40, distal housing 35, PCB 42 and light sources 45 can simultaneously provide visual interest, high illumination levels, low glare and good acoustic performance, while maintaining a high ratio of loudspeaker diameter to recessed can size. That is, while it is possible to provide very bright light from LEDs in a fixture of comparable size, bringing all of the light out of a small surface can easily cause visual discomfort due to the concentration of the light over a small emission area. Light pipe 50 spreads the illumination around a recessed ring (distal portion 60) having a vertical extent, and across grille portion 65, so as to spread out the light, thus reducing the light intensity per unit area. Also, an observer that is not directly underneath luminaire 10 may not see all of distal portion 60 (e.g., when the observer is at a higher angle with respect to luminaire 10 than the slope of distal portion 60). Yet, all of distal portion 60 will emit light into the surrounding space through a 360 degree azimuthal range, some of that light not being directly visible to the observer at a high angle.

Being able to make luminaire 10 with a small dimension DR as shown, also allows a high ratio of loudspeaker diameter to recessed can diameter. For example, luminaire 10 can be made with loudspeaker 40 having a nominal diameter of 2.25 inches while recessed can 20 has a nominal diameter of four inches. Thus, light pipe 50, providing the large illumination area of distal portion 60 as well as grille portion 65, and having the ability to use a relatively large loudspeaker in a small recessed can, enables a significant advantage in combined optical, acoustic and mechanical performance.

FIG. 2 is a partially exploded, schematic cross sectional view of a portion of luminaire 10, viewed at a downward angle and illustrating features advantageously found in certain embodiments. FIG. 3 is another partially exploded, schematic cross-sectional view of the same portion of the luminaire of FIG. 1, but viewed at an upward angle. FIGS. 2 and 3 show distal housing 35 (with integrated trim flange 25), proximal housing 30 (within optional recessed can 20), loudspeaker 40, optional reflector 80, and light pipe 50, positioned for example as they might be during assembly of light pipe 50 to distal housing 35. Can 20 is shown in FIGS. 2 and 3 for context only, and may not be present during assembly of light pipe 50 to distal housing 35. FIGS. 2 and 3 also illustrate circuit board 42 coupled with an underside of distal housing 35, and light sources 45 mounted with circuit board 42.

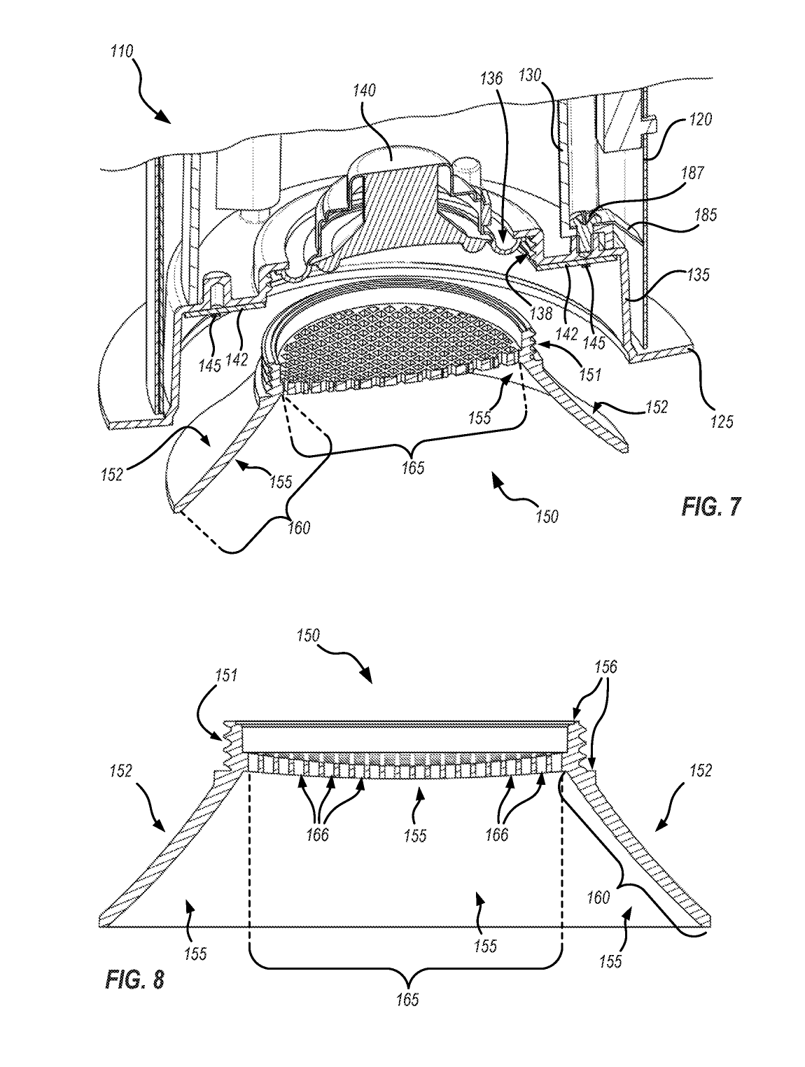

FIGS. 2 and 3 also illustrate light coupling surface 52, that receives light into light pipe 50 (from light sources 45), and optional stop features 56 that can be used to limit proximity of light coupling surface 52 to light sources 45. In embodiments, light coupling surface 52 can be arranged as needed on light pipe 50 to receive light from light sources 45 that may be placed differently than those shown in FIG. 2 (e.g., see FIG. 7). After light is received through light coupling surface 52 of light pipe 50, the light scatters and internally reflects within light pipe 50, and emits from light-emitting surfaces 55. Some of the scattering within light pipe 50 may be total internal reflection (e.g., when the light impinges on a surface of light pipe 50 at a shallow angle).

FIGS. 2 and 3 also illustrate optional threads 38 in an uppermost vertical riser (e.g., a transition from the uppermost step to the next uppermost step) of distal housing 35, and corresponding threads 51 on proximal portion 63 of light pipe 50, which is monolithically formed with grille portion 65 and distal portion 60. Proximal portion 63 extends upwardly from the perimeter of grille portion 65. Threads 38 and 51 can be considered examples of coupling features that engage light pipe 50 and distal housing 35; other types of coupling features are also possible. For example, coupling features could include snap fit or bayonet mount type features that may allow rotational adjustment after light pipe 50 couples with distal housing 35. Threads 38 and 51 simplify assembly, because both loudspeaker 40 and light pipe 50 can be assembled to distal housing 35 by placing a back (upper/proximal) side of loudspeaker 40 within the central aperture of distal housing 35, and then screwing threads 51 of light pipe 50 into threads 38 of distal housing 35. As can be seen in FIGS. 1-3, outer rim 41 of loudspeaker 40 is thus trapped between light pipe 50 and distal housing 35. In certain embodiments, as light pipe 50 screws into distal housing 35, one or more stop features 56, FIGS. 2 and 3, will come into contact with surfaces of distal housing 35 and/or circuit board 42. Alternatively, the vertical travel of light pipe 50 can be limited by a different stop feature contacting loudspeaker 40. Contact of any of stop features 56 with overlying structure limits vertical travel of light pipe 50, so that light coupling surface 52 can be close to light sources 45, without damaging them through contact. It may also be advantageous for a small gap to be present between the light sources 45 and light coupling surface 52, so that heat generated by light sources 45 transfers preferentially through circuit board 42 to distal housing 35 instead of into light pipe 50. For example, geometries of distal housing 35, circuit board 42, light sources 45 and relative heights of stop features 56 and light coupling surface 52 of light pipe 50 may be arranged to provide a gap of no more than two millimeters between light sources 45 and light coupling surface 52. Once heat has transferred to distal housing 35, it can easily transfer to trim flange 25, proximal housing 30 and/or recessed can 20 to dissipate from luminaire 10.

Use of light pipe 50 confers many advantages. For example, some sort of protective cover or grille is usually advantageous when a loudspeaker is present, but luminaires benefit from having a clean, uncluttered appearance. When a loudspeaker is integrated with a luminaire, an associated loudspeaker cover may require an added visible surface, tending to clutter the visual appearance of the luminaire. Having light pipe 50 provide a protective cover provides a solution in which a single visible surface spans an entire underside of luminaire 10, except for perforations as needed to allow sound transmission. The perforations can be uniform across at least a portion of a sound-emitting side of loudspeaker 40, or can vary in size and arrangement for visual interest and/or acoustic performance. Furthermore, light-emitting surfaces 55 can be used to reduce an overall size of a luminaire that has a loudspeaker, relative to a standard recessed can size. That is, by using sloped sides of light pipe 50 as light-emitting surfaces, light from light sources 45 can be made to exit luminaire 10 in a diffused form for better visual comfort than provided by LEDs alone, without adding a great deal of lateral space around the area of loudspeaker 40. Still furthermore, light pipe 50 can, in embodiments, scatter a portion of light from light sources 45 up into grille portion 65, so that the sound emitting portion of luminaire 10 becomes a light-emitting surface 55 as well. This, too, enhances the ability to get a large amount of light out of luminaire 10 in a diffused form for visual comfort, without increasing size of luminaire 10. In certain embodiments, light pipe 50 enables a loudspeaker 40 having a nominal 2.125 inch diameter (e.g., 2.000 to 2.250 inch diameter) to be integrated with a luminaire that is mountable within a standard, nominal 4.000 inch (e.g., 3.8 to 4.2 inch diameter) recessed can. Use of light pipe 50 can also enable loudspeakers 40 to be integrated with luminaires that are mountable within smaller and larger recessed can sizes, such as nominal one inch, 1.5 inch, 2 inch, 3 inch, 5 inch, 6 inch and 8 inch sizes, as well as sizes that are larger, smaller or intermediate to those listed.

In certain embodiments, grille portion 65 can be formed of or coated with an opaque material, to prevent light emission from the sound emitting portion. Perforations in grille portion 65 can be of any shape, that is, although square perforations are illustrated in the drawings, other perforation shapes such as round, triangular, rectangular, and/or hexagonal shapes are possible. Upon reading and comprehending the present disclosure, one of ordinary skill in the art will readily conceive of many equivalents, extensions, and alternatives.

Light pipe 50 can, in embodiments, have surface finishes of various types on certain surfaces, to provide optical performance as desired. For example, light coupling surfaces 52 are typically clear, flat optical surfaces to promote efficient in-coupling of light from light sources 45 into light pipe 50. Optionally, an antireflective layer may be provided on light coupling surfaces 52, to promote efficient in-coupling. Also optionally, a coupling material may be disposed between and fill the gap between light sources 45 and light coupling surfaces 52; however, attention may be needed to the thermal transfer implications of such materials, and any effects of such materials contacting light sources 45. Use of a coupling material may be especially easy when light sources 45 are LEDs in raw or minimally packaged chip form, due to their planar form factor.

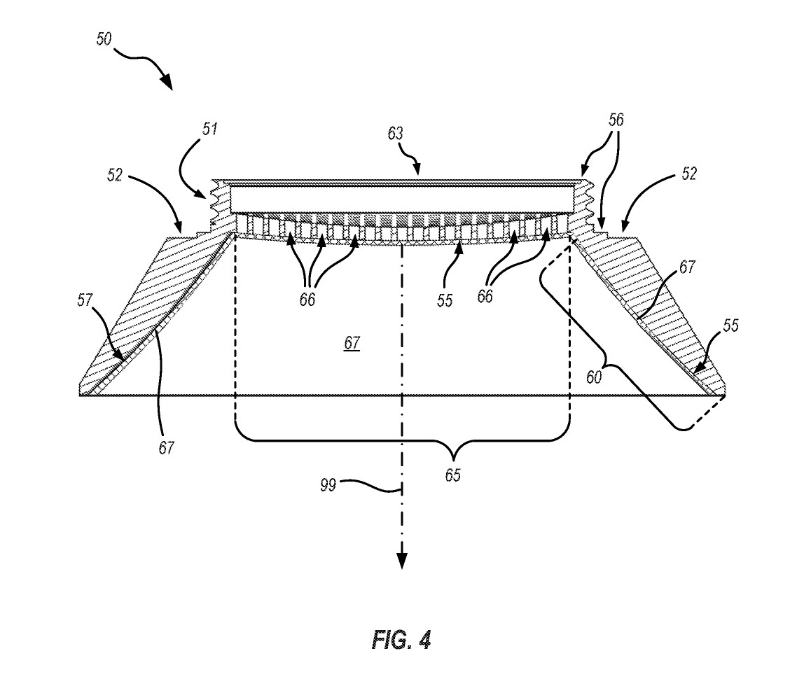

The light-emitting surfaces 55 can be provided with an optically rough surface, such as an etched or mechanically roughened surface, to diffuse light emitted thereby. For example, light-emitting surfaces 55 may display “hot spots” of brightness corresponding to individual ones of light sources 45, unless light-emitting surfaces 55 impart at least some diffusion. Light-emitting surfaces 55, as well as optional reflector 80, can also be provided with facets, or other refractive or reflective features, to orient emitted light toward specific directions, as desired. Light-emitting surfaces 55 can be provided with changes in angle and/or surface texture to provide points of visual interest. Surfaces where light emission from light pipe 50 is not desired may be coated or painted with a reflective coating so that the light is reflected back into light pipe 50 at those surfaces; such surfaces, also, can be provided with facets or formed at angles to direct the reflected light toward specific directions, as desired. For example, certain embodiments can provide a “wall wash” light distribution by directing a significant amount of the emitted light toward one particular side and/or at a high angle. One simple way to accomplish this is to provide a region of distal portion 60 of light pipe 50 with an opaque or reflective coating at certain azimuthal angles about optical axis 99 (see FIG. 4). During installation, luminaire 10 can be rotated so that the region with the coating faces a room interior, while regions without the coating face a nearby wall. The uncoated region will emit light toward the wall, while the coated region does not emit light into the room interior. Surfaces and/or material of light pipe 50 can also incorporate pigments, dyes or phosphors to alter the light emitted by luminaire 10 and/or to create visual interest.

Although light pipe 50 illustrated in FIGS. 1, 2 and 3 has a slight curvature from around a periphery of grille portion 65 toward the circular end of distal housing 35, this curvature is optional; in embodiments light pipe 50 can form any desired shape from the perforated surface to the end of distal housing 35 for optical and/or aesthetic purposes. For example, light pipe 50 can form a curved plane having a constant slope from the perforated surface to the end of distal housing 35. Light pipe 50 can also, in embodiments, extend beyond the end of distal housing 35, and can for example overlap with, or form, the trim flange. In still other embodiments, light pipe 50 may not extend to the end of distal housing 35.

Use of light pipe 50 can also facilitate assembly of a loudspeaker luminaire. For example, threads 51 on light pipe 50, and threads 38 on distal housing 35, can be used to assemble light pipe 50 to luminaire 10, as suggested in FIGS. 2 and 3. Luminaire 10 can, alternatively, be configured with different features, such as bayonet mount type features, to couple light pipe 50 with distal housing 35. Both threaded and bayonet mount features provide several advantages, including accurate alignment of light pipe 50 with the LEDs, an ability to easily remove and replace light pipe 50 either at the factory or after installation, and an ability to easily remove, replace and/or omit optional reflector 80, as desired, either at the factory or after installation. Accurate alignment of light pipe 50 with the LEDs is promoted by the proximity of the mounting region to the LEDs, the direct contact between the threaded surfaces of light pipe 50 with the speaker or distal housing, and the presence of stop features 56 noted above. Features of, or connected with, light pipe 50 may be provided for manipulation by an installer's hands or by tools; such features may be located away from light-emitting surfaces 55, to avoid contamination of the light-emitting surfaces. Alternatively, a custom tool for handling light pipe 50 may be created with features that engage perforations or other features of grille portion 65, for hands-free manipulation of light pipe 50.

Optional reflector 80 can also provide various advantages. Reflector 80 primarily reflects light that is directed toward an upward surface of distal portion 60, so that the light does not leave light pipe 50 upwardly within distal housing 35, where it might be undesirably absorbed and converted to heat. While custom coatings on the upward surface of light pipe 50 may also be used for this purpose, a simple metal finish or painted reflector may be less expensive to implement. Reflector 80 can be provided with one or more surface finishes, colors, surface features and/or angles to modify the reflected light; for example, in certain embodiments a reflector can provide or contribute to the “wall wash” light distribution noted above, by directing a significant amount of the emitted light toward one particular side and/or at a high angle. Reflector 80 may contribute to structural integrity of luminaire 10, and/or improve its thermal performance (e.g., promote heat removal from light sources 45).

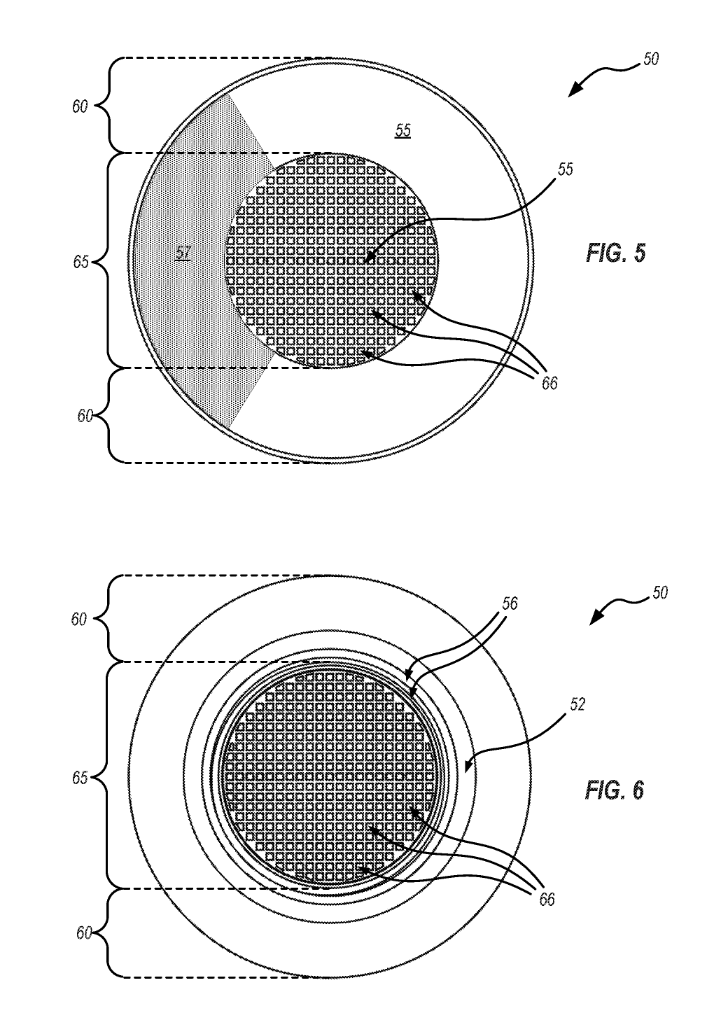

FIGS. 4, 5 and 6 illustrate light pipe 50 of luminaire 10. FIG. 4 provides a cross-sectional cutaway view, FIG. 5 provides a bottom plan view, and FIG. 6 provides a top plan view of light pipe 50. Light pipe 50 forms grille portion 65 for loudspeaker 40 (FIGS. 1-3), and distal portion 60 extends radially outwardly and downwardly from grille portion 65. Grille portion 65 is a perforated plate, forming perforations 66 so that sound can pass through. Although uniform, square perforations 66 are shown in FIGS. 4-6, such perforations could be of different shapes and sizes. Also, a percentage area of grille portion 65 that is solid may vary in embodiments; FIGS. 5 and 6 show a grille portion that is about 60 percent solid and 40 percent perforated area. Increasing an area percentage of grille portion 65 that is solid may increase a percentage of light that is emitted by grille portion 65 relative to that emitted by distal portion 60, and may increase protection afforded by grille portion 65 to loudspeaker 40. Lowering an area percentage of grille portion 65 that is solid may increase transmissibility of sound from loudspeaker 40 through grille portion 65. A reasonable balance of protection, light emission and sound transmission is found at solid area percentages of about fifty to seventy percent, although higher and lower solid area percentages are also possible. Distal portion 60 is similar to a truncated cone in FIGS. 4-6, but other shapes are possible.

In the embodiment shown, some distal surfaces of grille portion 65 and distal portion 60 form light-emitting surfaces 55. However, either grille portion 65 or distal portion 60, or both, or portions thereof, could form non-light-emitting surfaces 57, as shown in FIGS. 4 and 5. Non-light-emitting surfaces 57 can be created by forming the corresponding portions of light pipe 50 of different materials (e.g., opaque rather than transparent material) or through application of an opaque or reflective coating to those portions desired as non-light-emitting surfaces 57. In FIG. 4, one surface of distal portion 60 is shown with one such coating to form a non-light-emitting surface 57, which can be positioned adjacent a wall to create a “wall wash” effect. Non-light emitting surface 57 will not emit light toward a room, while light-emitting surface 55 positioned across from an adjacent wall will emit light toward the wall.

Threads 51 for coupling light pipe 50 to a housing are also shown. Light coupling surface 52 is shown as a horizontal, annular surface on part of an upper side of distal portion 60. Stop features 56 are shown; either stop feature 56 (e.g., above or below threads 51) could be used to set a gap between light coupling surface 52 and light sources coupled with a housing to which light pipe 52 attaches. FIG. 4 also shows a release liner 67 which may be applied to any or all distal (e.g., lower) surfaces of light pipe 50 to protect those surfaces from contamination and/or damage during installation. Release liner 67 may be, for example, a film that adheres to light pipe 50 weakly such that it can be easily peeled off of light pipe 50 after installation is complete.

FIG. 7 illustrates another luminaire 110 that includes a light pipe 150, and FIG. 8 provides a cross-sectional cutaway view of light pipe 150. In FIGS. 7 and 8, elements numbered congruently with elements illustrated in FIGS. 1-6 (e.g., elements 1XX in FIGS. 7 and 8 are numbered congruently with elements XX in FIGS. 1-6) are substantially similar to the congruently numbered elements previously described, except as discussed below.

Luminaire 110 includes a proximal housing 130 and a distal housing 135 (which may be combined into a single housing in other embodiments). Distal housing 135 couples with a loudspeaker 140, and a PCB 142 that provides power to light sources 145, which may be packaged or unpackaged LEDs. Loudspeaker 140 is oriented such that its sound emitting surface faces downward, to emit sound out of a distal end of luminaire 110. A back side of loudspeaker 140 may extend through a central aperture 136 of distal housing 135, as illustrated. Fasteners 187 used to join proximal and distal housings 130 and 135 may advantageously connect one or more retainers 185 that hold luminaire 110 within recessed can 120.

PCB 142 is typically affixed to an underside of distal housing 135 by one or more fasteners and/or adhesives, and the location at which PCB 142 is affixed may be an underside of a second step of distal housing 135, as illustrated. Luminaire 110 also includes a light pipe 150 that transfers light from light sources 145 to light-emitting surfaces 155. Light pipe 150 includes at least a distal portion 160 and a grille portion 165, as shown. Grille portion 165 is a perforated plate, forming perforations 166 so that sound can pass through. When loudspeaker 140 is circular, grille portion 165 will be a disk. Like perforations 66 shown in FIGS. 4-6, perforations 166 could be uniform and square, or of different shapes and sizes.

FIGS. 7 and 8 also illustrate optional threads 138 in an uppermost vertical riser (e.g., a transition from the uppermost step to the next uppermost step) of distal housing 135, and corresponding threads 151 of light pipe 50. Light pipe 150, PCB 142 and the locations of light sources 145 thereon differ from light pipe 50, PCB 42 and locations of light sources 45 (FIGS. 1-6) in that light sources 145 are provided at a greater radial distance from loudspeaker 40 than in luminaire 10, and light pipe 150 receives light from light sources 145 through a proximal surface 152. That is, light pipe 150 could be considered as “backlit” instead of receiving light through a horizontal light coupling surface, as in light pipe 50. Light sources 145 will not be in parallel and/or face-to-face relation with proximal surface 152, but will form an angle of at least ten degrees to proximal surface 152. Using the same definition of DR as in FIG. 1A, and assuming appropriate scale for a nominal four inch recessed can, DR for luminaire 110 may be five to twenty millimeters.

The configuration of light pipe 150, PCB 142 and locations of light sources 145 in luminaire 110 provides some similar and some different advantages from those of luminaire 10. For example, light pipe 150 may provide stop features 156 (as shown in FIG. 8) but it may be less important in luminaire 110 to control height of distal portion 160 of light pipe 150, than to control heights of corresponding features in luminaire 10. This is because the larger distance between light sources 145 and proximal surface 152 in luminaire 110, and elimination of the parallel and/or face-to-face relation between them, make contact and damage of light sources 145 less likely, and make small dimensional changes less likely to cause changes in light coupling. Also, because close proximity to a coupling surface is not an issue, light sources could be other than flat LED chips, such as packaged LEDs, eliminating handling and mounting challenges associated with LED chips. Weight and material usage of light pipe 150 may be reduced compared with light pipe 50. Different aesthetic effects may be producible by the “backlit” nature of distal portion 160. Luminaire 110 also eliminates reflector 80 of luminaire 10, and thus eliminates any cost, weight and assembly concerns associated with reflector 80. Light from light sources 145 may reflect partially from proximal surface 152, so it may be advantageous to make distal housing 135 and/or PCB 142 highly reflective so that light reflected from proximal surface 152 is re-reflected toward light pipe 150 and ultimately emitted from light-emitting surfaces 155. However, luminaire 110 still provides the advantageous combination of spreading emitted light over a large surface while maintaining good acoustic performance and enabling a high loudspeaker diameter to recessed can diameter, as luminaire 10.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described, are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A luminaire, comprising:
a loudspeaker coupled with a housing;
one or more light sources coupled with the housing; and
a light pipe, coupled with the housing, that forms a grille portion for the loudspeaker;
wherein the light pipe transfers light, from the light sources, to one or more light-emitting surfaces that emit the light from the luminaire.

2. The luminaire of claim 1, wherein no intervening structure is disposed between the grille portion and the loudspeaker.

3. The luminaire of claim 1, wherein the grille portion forms at least one of the one or more light-emitting surfaces.

4. The luminaire of claim 1, wherein when the housing is oriented so as to aim the loudspeaker outwardly from the luminaire, the light pipe forms a distal portion extending away from the grille portion, wherein the distal portion forms at least one of the one or more light-emitting surfaces.

5. The luminaire of claim 4, wherein the one or more light sources couple with the housing adjacent to an outer rim of the loudspeaker, and the light pipe forms a light coupling surface adapted to receive the light from the light sources.

6. The luminaire of claim 5, wherein:
the light coupling surface is planar;
the light sources emit the light toward the light coupling surface; and
the light coupling surface is in parallel relation with light-emitting surfaces of the light sources, with a gap formed therebetween.

7. The luminaire of claim 6, wherein a distance across the gap is no more than two millimeters.

8. The luminaire of claim 6, wherein:
the light pipe forms a threaded surface and one or more first stop features;
the housing forms:
a threaded surface that is configured to engage with the threaded surface of the light pipe, and
one or more second stop features; and
a distance across the gap is set by the first stop features coming into contact with the second stop features, as the light pipe is tightened threadedly with respect to the housing.

9. The luminaire of claim 4, wherein the one or more light sources couple with the housing at least five millimeters from an outer rim of the loudspeaker, and a proximal surface of the distal portion of the light pipe forms a light coupling surface to receive the light from the light sources.

10. The luminaire of claim 1, wherein the loudspeaker has an outer diameter of about 2.0 to 2.25 inches, and the housing and the light pipe are configured to fit within a nominal 4 inch diameter recessed can.

11. The luminaire of claim 1, wherein the housing and the light pipe are configured to fit within a recessed can that is mountable within a nominal one inch, 1.5 inch, 2 inch, 3 inch, 5 inch, 6 inch or 8 inch ceiling hole.

12. A light pipe, formed of an optical material and comprising:
a first portion that is a perforated plate of the optical material, the plate being characterized by a perimeter and defining a first light-emitting surface;
a second portion of the optical material that is monolithically formed with the first portion, wherein the second portion:
extends away from the perimeter of the plate,
forms one or more light coupling surfaces operable to receive light from one or more light sources, and
defines a second light-emitting surface;
wherein in operation, when the light is received into the one or more light coupling surfaces from the one or more light sources, at least a portion of the light emits from the first and second light-emitting surfaces.

13. The light pipe of claim 12, wherein, when the perforated plate faces nadir, at least one of the one or more light coupling surfaces is formed in a horizontal plane.

14. The light pipe of claim 12, wherein the second portion comprises a truncated cone, a proximal edge of the cone being monolithically integrated with the first portion along the perimeter of the perforated plate, the second portion extending radially outwardly and downwardly from the perimeter of the perforated plate.

15. The light pipe of claim 14, wherein:
the truncated cone forms a proximal surface and a distal surface;
the proximal surface forms at least one of the one or more light coupling surfaces; and
the distal surface forms the second light-emitting surface.

16. The light pipe of claim 15, wherein the proximal surface of the light pipe forms one or more features that modify directionality of the light.

17. The light pipe of claim 12, wherein solid areas of the perforated plate comprise at least fifty percent of an area of the perforated plate, and perforations form no more than fifty percent of the area of the perforated plate.

18. The light pipe of claim 12, further comprising a third portion that is monolithically formed with the first portion, wherein the third portion:
extends upwardly from the perimeter of the plate; and
forms one or more coupling features configured to engage with a luminaire housing.

19. The light pipe of claim 18, wherein the one or more coupling features include threads configured to rotatably engage corresponding threads of the luminaire housing.

20. The light pipe of claim 19, further comprising one or more stop features, such that when the threads engage the corresponding threads of the luminaire housing, and the one or more stop features abut corresponding features of the luminaire housing, the light pipe is at a predefined height with respect to the luminaire housing.
